(19) United States
(12) Patent Application Publication
(10) Pub. No.: US 2024/0400049 A1
(43) Pub. Date: Dec. 5, 2024

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Satoshi Sadamura, Tokyo (JP); Yoshihiko Kosegaki, Tokyo (JP)

(21) Appl. No.: 18/732,667

(22) Filed: Jun. 4, 2024

(30) Foreign Application Priority Data
Jun. 5, 2023 (JP) 2023-092271

(51) Int. Cl. B60W 30/14

(52) U.S. Cl. CPC B60W 30/143; B60W 2552/30; B60W 2720/10

(57) ABSTRACT

A vehicle control device includes a storage device storing a program and a hardware processor. The hardware processor executes the program stored in the storage device to perform: acquiring first information on a curved road present in a traveling direction of a vehicle; acquiring second information including an amount of accelerating operation of a driver of the vehicle; performing support control including one or both of deceleration control for decelerating the vehicle such that a speed of the vehicle approaches a target speed based on the first information and notification control for notifying that the speed of the vehicle approaches the target speed when the vehicle is traveling in a section from an entrance of the curved road to a position at a predetermined distance before the entrance or in the curved road; and stopping the support control when the amount of accelerating operation increases by a predetermined amount or more with reference to the second information while the support control is being performed.

### CROSS-REFERENCE TO RELATED APPLICATION

Priority is claimed on Japanese Patent Application No. 2023-092271, filed on Jun. 5, 2023, the contents of which are incorporated herein by reference.

### BACKGROUND

### Field of the Invention

The present invention relates to a vehicle control device, a vehicle control method, and a storage medium.

### Description of Related Art

Recently, measures for providing a sustainable transportation system in consideration of various situations have been actively realized. Focus has been put on research and development for further improving safety or convenience of traffic through research and development for driving support technology based on such realization. For example, an automatic brake device for applying a braking force to a vehicle not having yet entered a curve until the vehicle reaches a safety speed at which the vehicle can enter the curve safely has been disclosed (for example, Japanese Patent No. 5190022). This automatic brake device determines whether a distance to an entrance of a curve is equal to or greater than a predetermined distance, determines whether a driver has an intention of acceleration when it is determined that the distance is equal to or greater than the predetermined distance, and decreases a braking force according to whether the driver has an intention of acceleration.

In the related device, control of a vehicle based on a driver's intention may not be realized. For example, a vehicle may not be caused to accelerate according to a driver's intention.

The present invention was made in consideration of the aforementioned circumstances and can realize control of a vehicle according to a driver's intention. For example, it is possible to cause a vehicle to accelerate according to a driver's intention. In addition, it is possible to be considerate to an occupant and to contribute to development of a sustainable transportation system.

### SUMMARY

A notification control device, a notification control method, and a storage medium according to the present invention employ the following configurations.

(1) According to an aspect of the present invention, there is provided a vehicle control device including a storage device storing a program and a hardware processor, wherein the hardware processor executes the program stored in the storage device to perform: acquiring first information on a curved road present in a traveling direction of a vehicle; acquiring second information including an amount of accelerating operation of a driver of the vehicle; performing support control including one or both of deceleration control for decelerating the vehicle such that a speed of the vehicle approaches a target speed based on the first information and notification control for notifying that the speed of the vehicle approaches the target speed when the vehicle is traveling in a section from an entrance of the curved road to a position at a predetermined distance before the entrance or in the curved road; and stopping the support control when the amount of accelerating operation increases by a predetermined amount or more with reference to the second information while the support control is being performed.

(2) In the aspect of (1), the hardware processor stops the support control when the amount of accelerating operation increases by a predetermined amount or more from a reference value while the support control is being performed, and the reference value is set to the amount of accelerating operation at the time of start of the support control.

(3) In the aspect of (1), the hardware processor stops the support control when the amount of accelerating operation increases by a predetermined amount or more from a reference value while the support control is being performed, and the reference value is set to a minimum value of the amount of accelerating operation while the support control is being performed.

(4) According to another aspect of the present invention, there is provided a vehicle control method that is performed by a computer, the vehicle control method including: acquiring first information on a curved road present in a traveling direction of a vehicle; acquiring second information including an amount of accelerating operation of a driver of the vehicle; performing support control including one or both of deceleration control for decelerating the vehicle such that a speed of the vehicle approaches a target speed based on the first information and notification control for notifying that the speed of the vehicle approaches the target speed when the vehicle is traveling in a section from an entrance of the curved road to a position at a predetermined distance before the entrance or in the curved road; and stopping the support control when the amount of accelerating operation increases by a predetermined amount or more with reference to the second information while the support control is being performed.

(5) According to another aspect of the present invention, there is provided a non-transitory computer-readable storage medium storing a program, the program causing a computer perform: acquiring first information on a curved road present in a traveling direction of a vehicle; acquiring second information including an amount of accelerating operation of a driver of the vehicle; performing support control including one or both of deceleration control for decelerating the vehicle such that a speed of the vehicle approaches a target speed based on the first information and notification control for notifying that the speed of the vehicle approaches the target speed when the vehicle is traveling in a section from an entrance of the curved road to a position at a predetermined distance before the entrance or in the curved road; and stopping the support control when the amount of accelerating operation increases by a predetermined amount or more with reference to the second information while the support control is being performed.

According to the aspects of (1) to (5), the vehicle control device, the vehicle control method, or the storage medium can realize control of a vehicle based on a driver's intention by causing the hardware processor to perform acquiring an amount of operation on an operator of the vehicle in the accelerating operation from the second information and stopping the support control when the amount of operation increases by a predetermined amount or more. Particularly, in any of a case in which a driver performs an operation of increasing an amount of operation of an operator greatly for a short time and a case in which the driver performs an operation of increasing the amount of operation gradually for a long time, it is possible to perform an override of support control with an accelerating operation and to realize control of a vehicle based on the driver's intention.

According to the aspect of (2), since the reference value is set to an amount of operation on the operator at the time of start of the support control, it is possible to set an amount of operation required for performing an override of the support control with the same reference and to allow a driver to easily ascertain the amount of operation required for performing an override.

According to the aspect of (3), since the reference value is set to a minimal value of the amount of operation on the operator while the support control is being performed, it is possible to allow a driver to perform an override even when the amount of operation at the time of start of the support control is large and a spare amount of operation remaining a maximal amount of operation is less than a predetermined amount.

### BRIEF DESCRIPTION OF THE DRAWINGS

FIG. 1 is a diagram illustrating a configuration of a vehicle system employing a vehicle control device according to an embodiment.

FIG. 2 is a diagram illustrating an example of driving support control.

FIG. 3 is a diagram illustrating a reference value for determining execution of an accelerator override and execution of the accelerator override based on the reference value.

FIG. 4 is a diagram illustrating a reference value for determining execution of an accelerator override and execution of the accelerator override based on the reference value.

FIG. 5 is a diagram illustrating an advantage of an accelerator override according to the embodiment.

FIG. 6 is a flowchart illustrating an example of a process flow that is performed by a driving support device.

FIG. 7 is a flowchart illustrating an example of an accelerator override process that is performed by the driving support device.

### DESCRIPTION OF EMBODIMENTS

Hereinafter, a vehicle control device, a vehicle control method, and a storage medium according to an embodiment of the present invention will be described with reference to the accompanying drawings.

### Embodiment

### Entire Configuration

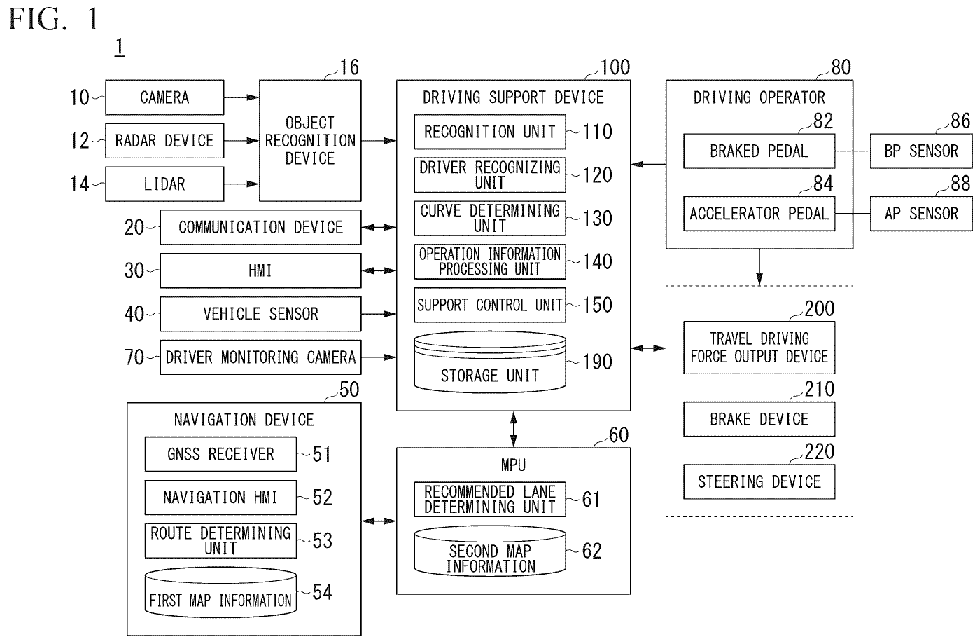

FIG. 1 is a diagram illustrating a configuration of a vehicle system 1 employing a vehicle control system according to an embodiment. A vehicle in which the vehicle system 1 is mounted is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell.

The vehicle system 1 includes, for example, a camera 10, a radar device 12, a Light Detection and Ranging (LIDAR) device 14, an object recognition device 16, a communication device 20, a human-machine interface (HMI) 30, a vehicle sensor 40, a navigation device 50, a map positioning unit (MPU) 60, a driver monitoring camera 70, a driving operator 80, a driving support device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration illustrated in FIG. 1 is only an example, and a part of the configuration may be omitted or another configuration may be added thereto. The driving support device 100 is an example of a “vehicle control device.”

The camera 10 is, for example, a digital camera using a solid-state imaging device such as a charge coupled device (CCD) or a complementary metal oxide semiconductor (CMOS). The camera 10 is attached to an arbitrary position on a vehicle in which the vehicle system 1 is mounted (hereinafter referred to as a vehicle M). When the front view of the vehicle is imaged, the camera 10 is attached to an upper part of a front windshield, a rear surface of a rearview mirror, or the like. The camera 10 images the surroundings of the vehicle M, for example, periodically and repeatedly. The camera 10 may be a stereo camera.

The radar device 12 radiates radio waves such as millimeter waves to the surroundings of the vehicle M, detects radio waves (reflected waves) reflected by an object, and detects at least a position (a distance and a direction) of the object. The radar device 12 is attached to an arbitrary position on the vehicle M. The radar device 12 may detect a position and a speed of an object using a frequency modulated continuous wave (FM-CW) method.

The LIDAR device 14 radiates light (or electromagnetic waves of wavelengths close to light) to the surroundings of the vehicle M and measures scattered light. The LIDAR device 14 detects a distance to an object on the basis of a time from radiation of light to reception of light. The radiated light is, for example, a pulse-like laser beam.

The LIDAR device 14 is attached to an arbitrary position on the vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the driving support device 100. The object recognition device 16 may output the results of detection from the camera 10, the radar device 12, and the LIDAR device 14 to the driving support device 100 without any change. The object recognition device 16 may be omitted from the vehicle system 1.

The communication device 20 communicates with other vehicles near the vehicle M, for example, using a cellular network, a Wi-Fi network, Bluetooth (registered trademark), or dedicated short range communication (DSRC) or communicates with various server devices via radio base stations.

The HMI 30 presents various types of information to an occupant of the vehicle M and receives an input operation from the occupant. The HMI 30 includes, for example, various display devices, a speaker, a buzzer, a touch panel, a switch, and keys. The HMI 30 includes a display device. The display device (a display unit) is, for example, a display device, that is, a multi-information display, that is provided at the center of an instrument panel of the vehicle M and displays various types of information in the vehicle M such as a speed meter (a speedometer) displaying a traveling speed of the vehicle M or a revolution counter (a tachometer) showing the number of revolutions (a rotation speed) of the internal combustion engine provided in the vehicle M.

The vehicle sensor 40 includes a vehicle speed sensor that detects a speed of the vehicle M, an acceleration sensor that detects acceleration, a yaw rate sensor that detects an angular velocity around a vertical axis, and a direction sensor that detects a direction of the vehicle M.

The navigation device 50 includes, for example, a global navigation satellite system (GNSS) receiver 51, a navigation HMI 52, and a route determining unit 53. The navigation device 50 stores first map information 54 in a storage device such as a hard disk drive (HDD) or a flash memory. The GNSS receiver 51 identifies a position of the vehicle M on the basis of signals received from GNSS satellites. The position of the vehicle M may be identified or corrected by an inertial navigation system (INS) using the output of the vehicle sensor 40. The navigation HMI 52 includes a display device, a speaker, a touch panel, and keys. The navigation HMI 52 may be partially or wholly shared by the HMI 30. For example, the route determining unit 53 determines a route (hereinafter referred to as a route on a map) from the position of the vehicle M identified by the GNSS receiver 51 (or an input arbitrary position) to a destination input by an occupant using the navigation HMI 52 with reference to the first map information 54. The first map information 54 is, for example, information in which a road shape is expressed by links indicating a road and nodes connected by the links. The first map information 54 may include a curvature of a road and point of interest (POI) information. The route on a map is output to the MPU 60. The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determining unit 61 and stores second map information 62 in a storage device such as an HDD or a flash memory. The recommended lane determining unit 61 divides a route on a map provided from the navigation device 50 into a plurality of blocks (for example, every 100 [m] in a vehicle traveling direction) and determines a recommended lane for each block with reference to the second map information 62. The recommended lane determining unit 61 determines in which lane from the leftmost the vehicle is to travel. When there is a branching point in the route on a map, the recommended lane determining unit 61 determines the recommended lane such that the vehicle M travels along a rational route for traveling to a branching destination.

The second map information 62 is map information with higher precision than the first map information 54. For example, the second map information 62 may include information of centers of lanes and information of boundaries of lanes. The second map information 62 may include road information, traffic regulation information, address information (addresses and postal codes), facility information, and phone number information. The second map information 62 may be updated from time to time by causing the communication device 20 to communicate with another device. The second map information 62 includes information such as a position of a curved road, a curvature of a curved road, a curve radius of a curved road, and a gradient of a curved road. These pieces of information may be included in the first map information 54. The second map information 62 or the first map information 54 may include information indicating a curved road which is a target of support control which will be described later.

The driver monitoring camera 70 is, for example, a digital camera using a solid-state imaging device such as a CCD or a CMOS. The driver monitoring camera 70 is attached to an arbitrary position on the vehicle M in a place and a direction in which the head of an occupant (hereinafter referred to as a driver) sitting on a driver's seat of the vehicle M can be imaged from the front (such that the face of the driver is imaged). For example, the driver monitoring camera 70 is attached to an upper part of a display device which is provided at the central part of an instrument panel of the vehicle M. The driver monitoring camera 70 outputs an image obtained by imaging a cabin including the driver of the vehicle M from the position at which it is installed to the driving support device 100.

The driving operator 80 includes, for example, a brake pedal 82, an accelerator pedal 84, a steering wheel, an operation switch of a direction indicator, a shift lever, and other operators. A sensor that detects an amount of operation or performing of an operation is attached to the driving operator 80. A result of detection of the sensor is output to the driving support device 100 or output to some or all of the travel driving force output device 200, the brake device 210, and the steering device 220. The steering wheel does not have to have a ring shape and may have a shape of a deformed steering, a joystick, a button, or the like. A brake pedal (BP) sensor 86 is attached to the brake pedal 82. An accelerator pedal (AP) sensor 88 is attached to the accelerator pedal 84.

The BP sensor 86 detects an amount of operation of the brake pedal 82 that varies according to the driver's operation of the brake pedal 82. The AP sensor 88 detects an amount of operation of the accelerator pedal that varies according to the driver's operation of the accelerator pedal 84.

The driving support device 100 includes, for example, a recognition unit 110, a driver recognizing unit 120, a curve determining unit 130, an operation information processing unit 140, a support control unit 150, and a storage 190. Some or all of these functional units are realized, for example, by causing a hardware processor such as a central processing unit (CPU) to execute a program (software). Some or all of these elements may be realized by hardware (a circuit part including circuitry) such as a large scale integration (LSI) device, an application-specific integrated circuit (ASIC), or a field-programmable gate array (FPGA), or a graphics processing unit (GPU) or may be cooperatively realized by software and hardware. The program may be stored in a storage device (a storage device including a non-transitory storage medium) such as an HDD or a flash memory of the driving support device 100 in advance, or may be stored in a removable storage medium such as a DVD or a CD-ROM and installed in the HDD or the flash memory of the driving support device 100 by setting the removable storage medium (a non-transitory storage medium) into a drive device. The curve determining unit 130 is an example of a first acquisition unit, the operation information processing unit 140 is an example of a second acquisition unit, and the support control unit 150 is an example of a control unit.

The storage 190 may be realized, for example, by an HDD, a flash memory, an electrically erasable programmable read only memory (EEPROM), a read only memory (ROM), or a random access memory (RAM).

The recognition unit 110 recognizes states such as a position, a speed, and an acceleration of an object near the vehicle M on the basis of information input from the camera 10, the radar device 12, the LIDAR device 14 via the object recognition device 16. For example, a position of an object is recognized as a position in an absolute coordinate system with an origin set to a representative point of the vehicle M (such as the center of gravity or the center of a drive shaft) and is used for control. A position of an object may be expressed as a representative point such as the center of gravity or a corner of the object or may be expressed as an area. A “state” of an object may include an acceleration or a jerk of the object or a “moving state” (for example, whether lane change is being performed or whether lane change is going to be performed) thereof.

The recognition unit 110 recognizes, for example, a lane (a traveling lane) in which the vehicle M is traveling. For example, the recognition unit 110 recognizes the traveling lane through comparison between patterns of road markings (for example, arrangement of a solid line and a dotted line) obtained from the second map information 62 and patterns of road markings near the vehicle M recognized from an image captured by the camera 10. The recognition unit 110 is not limited to road markings, and may recognize the traveling lane by recognizing the road markings or traveling lane boundaries (road boundaries) including edges of roadsides, curbstones, median strips, guard rails, and the like. In this recognition, the position of the vehicle M acquired from the navigation device 50 or the result of processing from the INS may be considered. The recognition unit 110 recognizes a stop line, an obstacle, a red signal, a toll gate, or other road events.

The recognition unit 110 recognizes a position or a direction of the vehicle M with respect to a traveling lane at the time of recognition of the traveling lane. The recognition unit 110 may recognize, for example, a separation of a reference point of the vehicle M from the lane center and an angle of the traveling direction of the vehicle M with respect to a line formed by connecting the lane centers in the traveling direction as the position and the direction of the vehicle M with respect to the traveling lane. Instead, the recognition unit 110 may recognize a position of a reference point of the vehicle M with respect to one side line of the traveling lane (a road marking or a road boundary) or the like as the position of the vehicle M with respect to the traveling lane.

The driver recognizing unit 120 detects whether the driver is in a predetermined state on the basis of an image captured by the driver monitoring camera 70. The predetermined state is a state in which hands-off lane keeping control which will be described later is executable. Hands-off is a state in which a driver is not grasping the steering wheel, and hands-on is a state in which a driver grasps the steering wheel. The state in which hands-off lane keeping control is executable is a state in which a driver is monitoring forward (or the surroundings of the vehicle M). Forward monitoring is, for example, a state in which a driver monitors forward such that the driver can rapidly take over manual operation of the vehicle M from control of the vehicle M by the vehicle system 1. Forward monitoring is, for example, a state in which a sightline of a driver faces forward. Whether a driver is in a hands-on state or hands-off state is determined on the basis of a result of detection of a grasp sensor for detecting a grasp state of the steering wheel which is not illustrated.

The curve determining unit 130 acquires first information on a curved road present in a traveling direction of the vehicle M. The first information on a curved road is, for example, information on a position of the curved road or a shape of the curved road. The curve determining unit 130 identifies a position of the curved road with respect to the vehicle M, for example, on the basis of the position of the vehicle M and the first information.

The operation information processing unit 140 acquires second information on an accelerating operation of the driver of the vehicle M. The second information is, for example, information indicating an accelerator pedal operation amount output from the AP sensor 88. The operation information processing unit 140 acquires information on a decelerating operation of the driver of the vehicle M. For example, the operation information processing unit 140 acquires information indicating a braked pedal operation amount output from the BP sensor 86.

The support control unit 150 supports the driver in association with control of the vehicle M. For example, the support control unit 150 automatically controls the travel driving force output device 200 and the brake device 210 regardless of the driver's operation such that the speed of the vehicle M is automatically controlled. The support control unit 150 performs so-called adaptive cruise control (ACC).

For example, when another vehicle is not present in a predetermined distance from the vehicle M in front of the vehicle M, the support control unit 150 automatically controls the travel driving force output device 200 and the brake device 210 regardless of the driver's operation such that the vehicle M travels at a speed set by the driver, a speed limit, or a speed preset according to the road.

For example, when another vehicle is present in a predetermined distance from the vehicle M in front of the vehicle M, the support control unit 150 automatically controls the travel driving force output device 200 and the brake device 210 regardless of the driver's operation such that the vehicle M follows the other vehicle. Following is the vehicle M traveling while maintaining a position at a predetermined distance from the other vehicle at the back of the other vehicle.

The support control unit 150 controls the steering device 220 such that the vehicle M does not depart from the traveling lane. For example, the support control unit 150 controls the steering device 220 such that the vehicle M travels at the center of the traveling lane recognized by the recognition unit 110 or in the vicinity of the center. The support control unit 150 performs, for example, hands-off lane keeping control in which a driver can control steering of the vehicle M in a state in which the driver does not grasp the steering wheel or hands-on lane keeping control in which the driver can control steering of the vehicle M in a state in which the driver grasps the steering wheel.

The support control unit 150 automatically changes the lane of the vehicle M. For example, the support control unit 150 generates a trajectory for lane change and changes the lane of the vehicle M such that the vehicle M travels along the generated trajectory. The support control unit 150 changes the lane of the vehicle M (auto lane change (ALC) on the basis of a destination set by an occupant or a recommended lane output to the MPU 60.

When the driver instructs lane change, the support control unit 150 may automatically change the lane of the vehicle M. An instruction for lane change is an operation of a lever portion of an operation switch of a direction indicator. For example, when the driver operates the lever part in a direction in which the driver wants to change the lane of the vehicle M, the support control unit 150 changes the lane of the vehicle M in the direction corresponding to the operation. The instruction for lane change may be an operation other than the operation of the lever portion of the operation switch of the direction indicator. For example, when a predetermined operation button is pushed, lane change may be performed. A part or whole of the control of the support control unit 150 may be omitted.

The support control unit 150 supports the driver such that the vehicle M can travel smoothly along a curved road by decelerating the vehicle M to a speed corresponding to the curved road or notifying the driver of deceleration when the vehicle M enters the curved road or is traveling on the curved road. In the following description, this control may be referred to as support control.

The travel driving force output device 200 outputs a travel driving force (a torque) for allowing the vehicle M to travel to driving wheels. The travel driving force output device 200 includes, for example, a combination of an internal combustion engine, an electric motor, and a transmission and an electronic control unit (ECU) that controls them. The ECU controls the aforementioned elements on the basis of information input from the support control unit 150 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the support control unit 150 or the information input from the driving operator 80 such that a brake torque based on a braking operation is output to vehicle wheels.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the support control unit 150 or the information input from the driving operator 80 to change the direction of the turning wheels.

### Support Control

The support control unit 150 performs support control including one or both of deceleration control for decelerating the vehicle M such that the speed of the vehicle M approaches a target speed corresponding to a curved road and notification control for notifying (giving an alarm indicating) that the speed of the vehicle M approaches the target speed when the vehicle M is traveling in a section (a predetermined section) from an entrance of the curved road to a position at a predetermined distance before the curved road or the vehicle M is traveling on the curved road. The support control is, for example, a process that is performed when a driver controls the speed of the vehicle M such that the driving support device 100 does not automatically control the speed of the vehicle M (for example, such that an ACC does not operate). The target speed is a speed that is determined on the basis of a shape of the curved road, a speed limit of the curved road, or the like.

A target of the support control may be a curved road satisfying a condition. The condition is, for example, a condition in which a curve radius is in a predetermined range. The predetermined range is a curve radius in which deceleration is required when the vehicle M travels.

The support control may be performed on the basis of the premise that the speed of the vehicle M is equal to or lower than a predetermined speed. The predetermined speed is a speed which is not separated by a predetermined speed or more from a speed limit or a recommended speed of the curved road or a road before or after the curved road. The predetermined speed is, for example, a speed obtained by adding a set speed (for example, 30 km/h) to the speed limit or the recommended speed.

The support control may be performed when road conditions satisfy a reference. Satisfaction of the reference means, for example, that an event affecting a braking operation such as an event in which a road is frozen has not occurred. For example, the recognition unit 110 may recognize the road conditions on the basis of the detection result from the object recognition device 16, or the driving support device 100 may recognize the road conditions on the basis of information provided from another device. The support control may be performed when the gradient of the curved road is less than a threshold value.

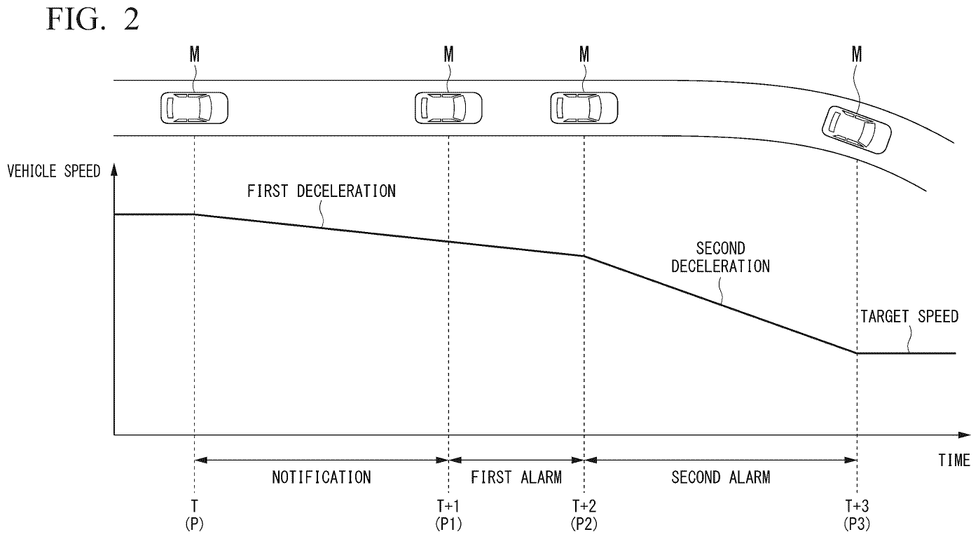

FIG. 2 is a diagram illustrating the support control. Time T is a timing at which the vehicle M arrives at a position P in a predetermined distance before an entrance of a curved road. The position at a predetermined distance is a position which is preset according to a target speed. The position at the predetermined distance is set to, for example, a position which is farther from the entrance of the curved road as a difference between the speed of the vehicle M and the target speed becomes larger. The position at the predetermined distance is set to a position at which a time in which preset notification is performed, a time in which a preset first alarm is given, and a time in which a preset second alarm is given can be secured when a brake override or an accelerator override is not performed as will be described later.

The vehicle M passes through the position P and then passes through positions P1, P2, and P3 in this order. A time at which the vehicle M arrives at the position P is time T, a time at which the vehicle M arrives at the position P1 is time T+1, a time at which the vehicle M arrives at the position P2 is tie T+2, and a time at which the vehicle M arrives at the position P3 is time T+3. An entrance of a curved road is located between the position P2 and the position P3. The entrance of a curved road is, for example, a position at which turning of a road (a lane) starts or a position at which the road is curved by a threshold value or more.

At time T1, when the speed of the vehicle M is higher than a target speed, the support control unit 150 notifies the driver and decelerates the vehicle M by a first degree of deceleration. The notification is a notification for allowing the driver to recognize the curved road. The notification is, for example, a notification indicating that the vehicle M approaches the curved road in a state in which the speed of the vehicle M is higher than the target speed or a notification indicating that support control for decelerating the vehicle M is started such that the speed of the vehicle M approaches the target speed. The notification is performed, for example, via the HMI 30. The notification may be a notification using an image or a notification using vocal sound or vibration (for example, vibration of a safety belt).

At time T+1, the support control unit 150 gives a first alarm to the driver. The first alarm is an alarm for causing the driver to recognize the curved road. The first alarm is, for example, an alarm that is given to the driver and an alarm for decelerating the vehicle M such that the speed of the vehicle M approaches the target speed.

At time T+1, the support control unit 150 gives a second alarm to the driver and decelerates the vehicle M by a second degree of deceleration. At time T+3, the support control unit 150 causes the speed of the vehicle M to match the target speed. The second degree of deceleration is a degree of deceleration which is larger than the first degree of deceleration. The second alarm is an alarm for causing the driver to recognize the curved road. The second alarm is, for example, an alarm that is given to the driver and an alarm for decelerating the vehicle M such that the speed of the vehicle M approaches the target speed. The second alarm is an alarm with a higher intensity than the first alarm. The alarm with a higher intensity is, for example, an alarm in which the driver is caused to feel higher necessity for deceleration. The alarm with a higher intensity is an alarm for causing the support control unit 150 to provide an image for prompting the driver to decelerate, to output larger vocal sound, or to deliver larger vibration to the driver.

### Override of Accelerating Operation

As described above, the support control unit 150 performs support such that the vehicle M travels on a curved road. Accordingly, it is possible to support the driver's operation such that the vehicle M travels on the curved road smoothly at the target speed. However, some drivers may feel troublesome from the support control (particularly, deceleration control) that is performed by the support control unit 150 or may intend to perform acceleration rather than deceleration of the vehicle M.

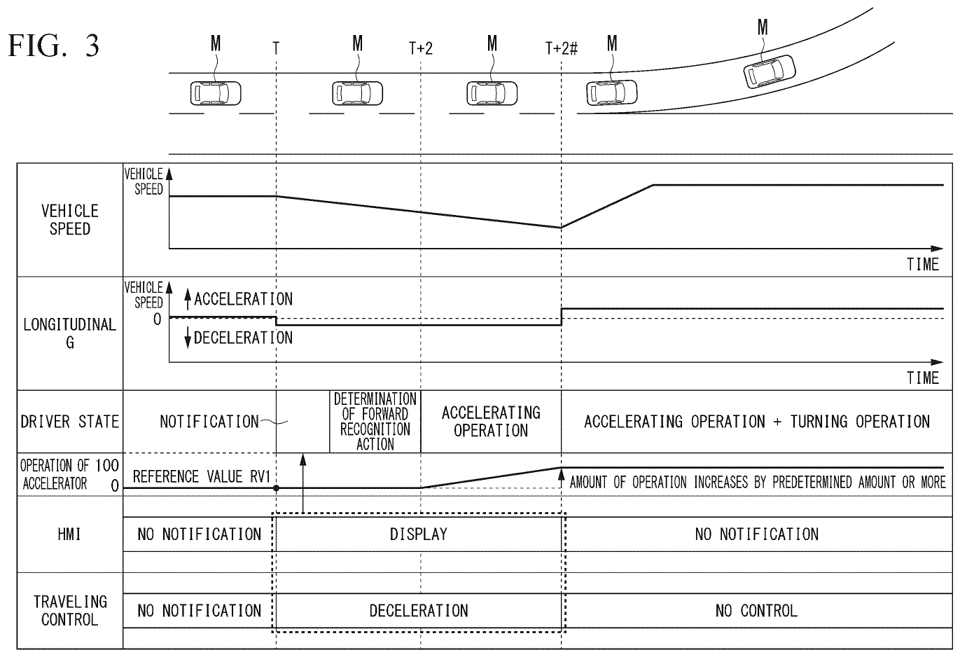

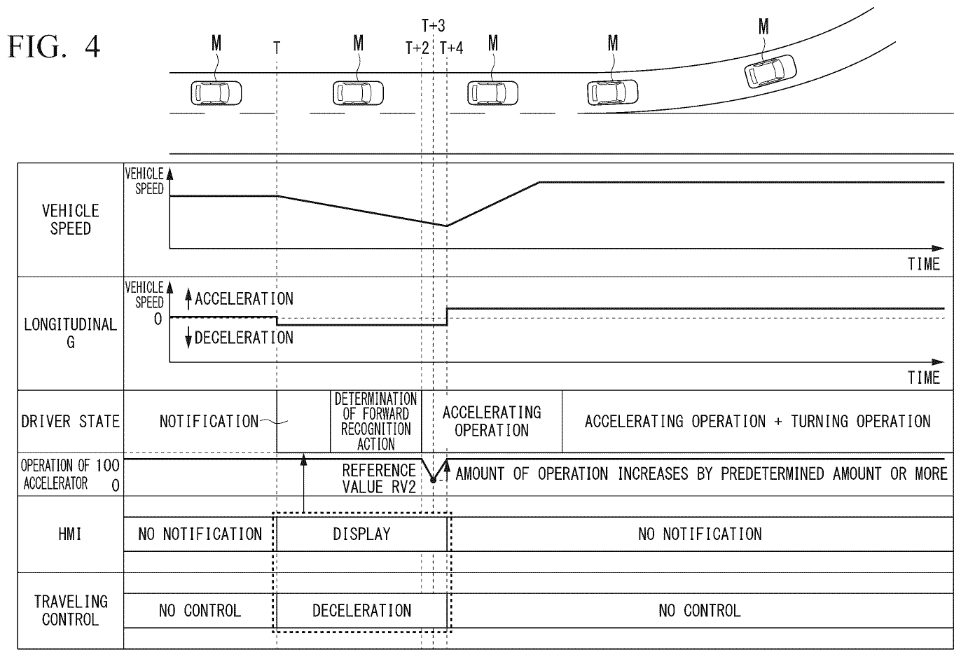

In such circumstances, when second information indicating that the driver has performed an accelerating operation when the support control is being performed is acquired, the support control unit 150 acquires an accelerator pedal operation amount output from the AP sensor 88 from the acquired second information and determines whether the accelerator pedal operation amount has increased by a predetermined amount or more from a reference value within a predetermined period (for example, several seconds). Here, a start point of the predetermined period may be, for example, a time point at which the driver has operated the accelerator pedal 84 when the support control is being performed or a time point at which the driver has operated the accelerator pedal 84 with an amount of operation equal to or greater than a predetermined amount. When it is determined that the accelerator pedal operation amount has increased by the predetermined amount or more from the reference value within the predetermined period, the support control unit 150 stops the support control and accelerates the vehicle M. In the following description, this control may be referred to as an accelerator override. The accelerator pedal operation amount is an example of an “amount of accelerating operation.” Alternatively, the support control unit 150 may measure a cumulative value of an increase of the accelerator pedal operation amount within the predetermined period and determine whether the measured cumulative value is equal to or greater than a predetermined amount. Setting of the reference value for determining execution of an accelerator override will be described below with reference to FIGS. 3 and 4.

FIG. 3 is a diagram illustrating a reference value RV1 for determining execution of an accelerator override and execution of the accelerator override based on the reference value RV1. In FIG. 3, at time T, the support control unit 150 performs support control such that the vehicle M is decelerated by the first degree of deceleration and a notification or a first alarm is given via the HMI 30. The driver feels a change of the gravity (a longitudinal G) in the traveling direction of the vehicle M due to deceleration of the vehicle M and additionally recognizes that the vehicle M approaches a curved road through the notification or the first alarm via the HMI 30. Here, it is assumed that the driver feels the situation, does not intend to perform support control, and starts an accelerating operation at time T+2.

When the driver starts the accelerating operation, the support control unit 150 acquires second information indicating that the driver has performed the accelerating operation and acquires an accelerator pedal operation amount output from the AP sensor 88 from the acquired second information. Then, the support control unit 150 determines whether the accelerator pedal operation amount has increased by a predetermined amount from a reference value RV1 within a predetermined period. Here, the reference value RV1 is a value of the accelerator pedal operation amount at time T at which the support control has been started by the support control unit 150. At time T+2 #, the support control unit 150 determines that the accelerator pedal operation amount has increased by the predetermined amount from the reference value RV1 within the predetermined period, stops the support control, and accelerates the vehicle M (performs an accelerator override) according to the accelerator pedal operation amount. Accordingly, it is possible to realize control of the vehicle corresponding to the driver's intention. When the reference value RV1 is set to the value of the accelerator pedal operation amount at the time of start of the support control, an amount of operation required for performing the accelerator override is set with the same reference, and the driver can more easily ascertain the amount of operation required for performing the accelerator override.

FIG. 4 is a diagram illustrating a reference value RV2 for determining execution of an accelerator override and execution of the accelerator override based on the reference value RV2. In FIG. 4, at time T, the support control unit 150 performs support control such that the vehicle M is decelerated by the first degree of deceleration and a notification or a first alarm is given via the HMI 30. The driver feels a change of the gravity (a longitudinal G) in the traveling direction of the vehicle M due to deceleration of the vehicle M and additionally recognizes that the vehicle M approaches a curved road through the notification or the first alarm via the HMI 30. Here, it is assumed that the driver feels the situation, does not intend to perform support control, and tries to perform an accelerator override.

Unlike the situation illustrated in FIG. 3, since the value of the accelerator pedal operation amount at time T at which the support control has been started is close to an upper limit, the value of the accelerator pedal operation amount may not be able to increase by a predetermined amount or more using the value as the reference value. Accordingly, the support control unit 150 sets a minimum value of the accelerator pedal operation amount when the support control is being performed as the reference value RV2 and determines whether the accelerator pedal operation amount has increased by a predetermined amount or more from the reference value RV2 within a predetermined period. For example, in FIG. 4, since the accelerator pedal operation amount becomes the minimum value by the driver returning the accelerator pedal 84 at time T+3, the support control unit 150 sets the value of the accelerator pedal operation amount at time T+3 as the reference value RV2. Thereafter, at time T+4, the support control unit 150 determines that the accelerator pedal operation amount has increased by the predetermined amount from the reference value RV2 within the predetermined period, stops the support control, and accelerates the vehicle M (performs the accelerator override) on the basis of the accelerator pedal operation amount. Accordingly, it is possible to realize control of the vehicle corresponding to the driver's intention. Since the reference value RV2 is set to the minimum value of the accelerator pedal operation amount when the support control is being performed, it is possible to cause the driver to perform an override even when the value of the accelerator pedal operation amount at the time of start of the support control is large and an amount of operation remaining up to the maximum amount of operation is less than a predetermined amount.

The reference value RV2 may be set by the support control unit 150 only when the accelerator pedal operation amount cannot increase by the predetermined amount or more from the value of the accelerator pedal operation amount at time T at which the support control has been started or may be normally set along with the reference value RV1 when the support control is performed.

### Advantages

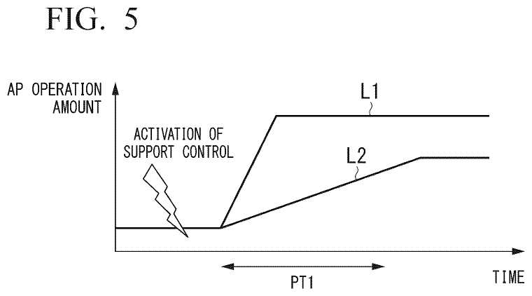

FIG. 5 is a diagram illustrating an average of an accelerator override according to the embodiment. The vertical axis represents the accelerator pedal operation amount, and the horizontal axis represents the time. The support control unit 150 stops the support control, for example, when the amount of accelerating operation on the accelerator pedal 84 reaches a threshold value until a predetermined period PT1 elapses after the accelerator pedal 84 has been operated to accelerate the vehicle M. When the integrated amount of operation does not reach until the predetermined period PT1 elapses, the support control is continued even if the driver operates the accelerator pedal 84.

When the accelerator pedal 84 is operated to rapidly change the accelerator pedal operation amount for a short time as indicated by a change line L1 (for example, the case illustrated in FIG. 4) and when the accelerator pedal 84 has been operated to slowly change the accelerator pedal operation amount as indicated by a change line L2 (for example, the case illustrated in FIG. 3), the conditions for the accelerator override are satisfied. Accordingly, in any of a case in which the driver performs an operation of rapidly increasing the amount of operation of the operator for a short time and a case in which the driver performs an operation of slowly increasing the amount of operation of the operator for a long time, it is possible to perform an override of the support control through the accelerating operation and to realize control of the vehicle corresponding to the driver's intention.

### Flowchart

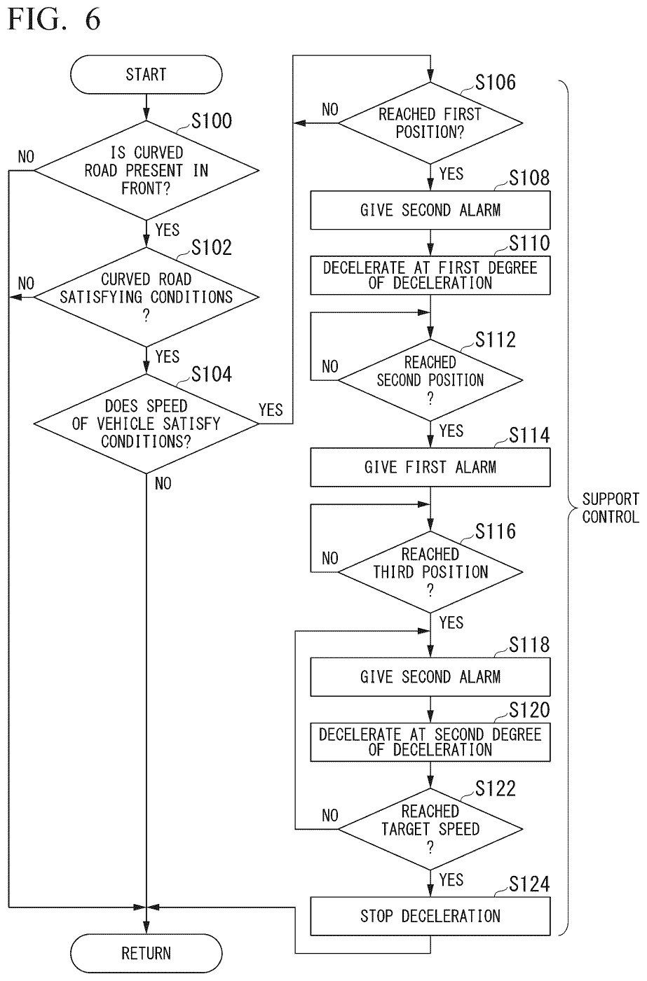

FIG. 6 is a flowchart illustrating an example of a process flow that is performed by the driving support device 100. The process order in the process flow of this flowchart may be changed, or some processes may be omitted.

First, the driving support device 100 determines whether a curved road is present in a predetermined distance in front of the position of the vehicle M (Step S100). When a curved road is present, the driving support device 100 determines whether the curved road is a curved road satisfying a condition (Step S102). When the curved road is a curved road satisfying the condition, the driving support device 100 determines whether the speed of the vehicle M satisfies a condition (Step S104). When the determination result of Step S100, S102, or S104 is negative, this routine of the flowchart ends.

When the speed of the vehicle satisfies the condition, the driving support device 100 determines whether the vehicle M has reached a first position (for example, the position P in FIG. 2) (Step S106). When the vehicle M has reached the first position, the driving support device 100 performs a notification (Step S108) and decelerates the vehicle M at a first degree of deceleration (Step S110).

Then, the driving support device 100 determines whether the vehicle M has reached a second position (for example, the position P1 in FIG. 2) (Step S112). When the vehicle M has reached the second position, the driving support device 100 gives a first alarm (Step S114). Then, the driving support device 100 determines whether the vehicle M has reached a third position (for example, the position P2 in FIG. 2) (Step S116).

When the vehicle M has reached the third position, the driving support device 100 gives a second alarm (Step S118) and decelerates the vehicle M at a second degree of deceleration (Step S122). Then, the driving support device 100 determines whether the speed of the vehicle M has reached a target speed (Step S122). When the speed of the vehicle M has not reached the target speed, the process flow returns to the process of Step S118. When the speed of the vehicle M has reached the target speed, the driving support device 100 stops deceleration f the vehicle M (Step S124). Then, this routine of the flowchart ends.

As described above, when the vehicle M and the curved road satisfy the conditions, the driving support device 100 can support the driver such that the vehicle M can travel on the curved road more smoothly by performing the support control (Steps S106 to S124).

In the process flow of the flowchart, when an accelerator override has been performed, the support control stops.

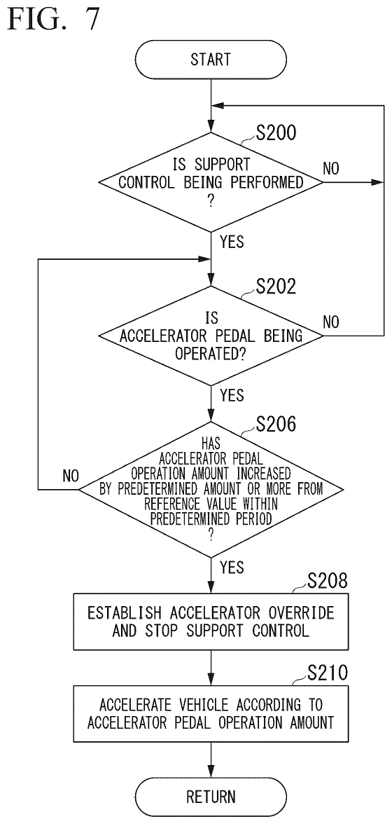

FIG. 7 is a flowchart illustrating an example of an accelerator override process that is performed by the driving support device 100. First, the driving support device 100 determines whether support control is being performed (Step S200). When the support control is being performed, the driving support device 100 determines whether the accelerator pedal 84 is being operated (Step S202). When it is determined that the accelerator pedal 84 is not being operated, the driving support device 100 returns the process flow to Step S200.

On the other hand, when it is determined that the accelerator pedal 84 is being operated, the driving support device 100 determines whether the accelerator pedal operation amount has increased by a predetermined amount or more from a reference value within a predetermined period (Step S206). When it is determined that the accelerator pedal operation amount has not increased by the predetermined amount or more from the reference value within the predetermined period, the driving support device 100 returns the process flow to Step S202.

When it is determined that the accelerator pedal operation amount has increased by the predetermined amount or more from the reference value within the predetermined period, the driving support device 100 determines that the accelerator override has been established and stops the support control of the flowchart illustrated in FIG. 7 (Step S208). Then, the driving support device 100 accelerates the vehicle M according to the accelerator pedal operation amount (Step S210). Then, the process flow of the flowchart ends.

At least one of the reference values RV1 illustrated in FIG. 3 and the reference value RV2 illustrated in FIG. 4 can be used as the reference value in Step S206. For example, in Step S206, the driving support device 100 may determine whether the accelerator pedal operation amount has increased by a predetermined amount or more from one of the reference value RV1 and the reference value RV2 within the predetermined period. Accordingly, in any of a case in which the driver performs an operation of rapidly increasing an amount of operation of the operator for a short time (the case corresponding to the reference value RV2) and a case in which the driver performs an operation of slowly increasing the amount of operation of the operator for a long time (the case corresponding to the reference value RV1), it is possible to perform an override of the support control using the accelerating operation and to realize control of the vehicle corresponding to the driver's intention.

According to the aforementioned embodiment, when the driver performs an accelerating operation while support control is being performed, the support control unit 150 determines whether an amount of operation in the accelerating operation has increased by a predetermined amount or more within a predetermined period and stops the support control when the amount of operation in the accelerating operation has increased by the predetermined amount or more. Accordingly, it is possible to realize control of the vehicle corresponding to the driver's intention.

The above-mentioned embodiment can also be expressed as follows:

A vehicle control device including:
a storage device storing a program; and
a hardware processor,
wherein the hardware processor executes the program stored in the storage device to perform:
   acquiring first information on a curved road present in a traveling direction of a vehicle;
   acquiring second information including an amount of accelerating operation of a driver of the vehicle;
   performing support control including one or both of deceleration control for decelerating the vehicle such that a speed of the vehicle approaches a target speed based on the first information and notification control for notifying that the speed of the vehicle approaches the target speed when the vehicle is traveling in a section from an entrance of the curved road to a position at a predetermined distance before the entrance or in the curved road; and
   stopping the support control when the amount of accelerating operation increases by a predetermined amount or more with reference to the second information while the support control is being performed.

While exemplary embodiments of the present invention have been described above, the present invention is not limited to the embodiments and can be subjected to various modifications and substitutions without departing from the gist of the present invention.

What is claimed is:

1. A vehicle control device comprising:
a storage device storing a program; and
a hardware processor,
wherein the hardware processor executes the program stored in the storage device to perform:
acquiring first information on a curved road present in a traveling direction of a vehicle;
acquiring second information including an amount of accelerating operation of a driver of the vehicle;
performing support control including one or both of deceleration control for decelerating the vehicle such that a speed of the vehicle approaches a target speed based on the first information and notification control for notifying that the speed of the vehicle approaches the target speed when the vehicle is traveling in a section from an entrance of the curved road to a position at a predetermined distance before the entrance or in the curved road; and
stopping the support control when the amount of accelerating operation increases by a predetermined amount or more with reference to the second information while the support control is being performed.

2. The vehicle control device according to claim 1, wherein the hardware processor stops the support control when the amount of accelerating operation increases by a predetermined amount or more from a reference value while the support control is being performed, and
wherein the reference value is set to the amount of accelerating operation at the time of start of the support control.

3. The vehicle control device according to claim 1, wherein the hardware processor stops the support control when the amount of accelerating operation increases by a predetermined amount or more from a reference value while the support control is being performed, and
wherein the reference value is set to a minimum value of the amount of accelerating operation while the support control is being performed.

4. A vehicle control method that is performed by a computer, the vehicle control method comprising:
acquiring first information on a curved road present in a traveling direction of a vehicle;
acquiring second information including an amount of accelerating operation of a driver of the vehicle;
performing support control including one or both of deceleration control for decelerating the vehicle such that a speed of the vehicle approaches a target speed based on the first information and notification control for notifying that the speed of the vehicle approaches the target speed when the vehicle is traveling in a section from an entrance of the curved road to a position at a predetermined distance before the entrance or in the curved road; and
stopping the support control when the amount of accelerating operation increases by a predetermined amount or more with reference to the second information while the support control is being performed.

5. A non-transitory computer-readable storage medium storing a program, the program causing a computer perform:
acquiring first information on a curved road present in a traveling direction of a vehicle;
acquiring second information including an amount of accelerating operation of a driver of the vehicle;
performing support control including one or both of deceleration control for decelerating the vehicle such that a speed of the vehicle approaches a target speed based on the first information and notification control for notifying that the speed of the vehicle approaches the target speed when the vehicle is traveling in a section from an entrance of the curved road to a position at a predetermined distance before the entrance or in the curved road; and
stopping the support control when the amount of accelerating operation increases by a predetermined amount or more with reference to the second information while the support control is being performed.
